(19) United States
(12) Patent Application Publication
(10) Pub. No.: US 2017/0076007 A1
(43) Pub. Date: Mar. 16, 2017

(54) SYSTEMS AND METHODS FOR AUTOMATED DELIVERY OF INFORMATION TO USER DEVICES

(71) Applicant: Inbound Retargeting Technologies Inc., Vancouver (CA)

(72) Inventors: Thomas KNOLL, Maplewood, MN (US); Warner ONSTINE, Las Vegas, NV (US); Serge SALAGER, Vancouver (CA); Samuel VINCENT, Vancouver (CA)

(21) Appl. No.: 15/265,766

(22) Filed: Sep. 14, 2016

Related U.S. Application Data
(60) Provisional application No. 62/219,033, filed on Sep. 15, 2015.

(51) Int. Cl. G06F 17/30; G06Q 30/02

(52) U.S. Cl. CPC G06F 17/30887; G06Q 30/0255

(57) ABSTRACT

A redirecting server generates interstitial web pages that redirect requests from user devices for alias URLs to corresponding destination URLs. The interstitial web pages tag user devices. In some embodiments the interstitial web pages include commands that provide cookies to the user devices. In some embodiments the interstitial web pages acquire ID characteristics from user devices. The cookies may persist on the user devices for some time and may cause information, for example in the form of banner advertisements to be displayed on the user devices. The information may be related to information contained in a resource identified by the destination URL. Some embodiments compile databases of concepts, keywords and/or key phrases represented in resources identified by the destination URLs. In such embodiments the concepts, keywords and/or key phrases may be associated with the alias URLs. The cookies may be selected from among a set of cookies based in part on the associated concepts, keywords and/or key phrases.

### FIELD

This invention relates to computer systems, methods, and devices, particularly, systems operable to deliver content such as text, video, and/or images to users. Some embodiments provide redirection facilities and methods operable to redirect requests for an internet resource from an alias URL to a destination URL.

### BACKGROUND

The internet has become the source of a wide variety of information for many consumers. As such, the internet is replacing media such as radio, television, printed newspapers, and printed magazines as the source that many people rely on for information regarding current events, the views of others, products and services, academic and technical information, and entertainment. Since the internet is relied upon so much as a source of information, the internet is also an important channel for businesses and other groups who wish to disseminate information about their products, services, viewpoints, or the like. Various systems currently exist for displaying advertisements such as banner advertisements on web pages. One problem with some such systems is that the advertisements or other information may be displayed to computer users who have no interest in the information being displayed to them.

Google™ and other search engines have the advantage that they have access to search criteria input by users. The search criteria generally indicate things that the users are currently interested in. Search providers are therefore well placed to select for display advertisements that are matched to the interests of users who are using their search facilities.

Another technique that can be applied to identify users who have specific interests is through the use of cookies. Cookies are small pieces of data which originate from websites that users visit and are stored on users' computers. When a user using a web browser visits an internet website, one or more cookies may be uploaded from the website into the user's browser. The cookie(s) may be used to identify the advertisements or other information of potential interest to the user as may be inferred from the user's browsing history. Cookies are described, for example, in RFC2965 available at tools.ietf.org\html\rfc2965.

Another way to identify a user device is by way of a characteristic that is specific to the user device. For example, a user device may have a static network address (e.g. an internet protocol version 6 or “IPv6” address) or a fingerprint representing a configuration (hardware and/or software) of aspects of the user device (e.g. HTML5 canvas fingerprinting) or an ID provided in a hardware device, a cryptographic certificate or the like.

There remains a need for methods and apparatus operable to deliver relevant advertisements or other information to users. There is a particular need for such methods and apparatus which provide mechanisms for selecting advertisements or other information for the users based on the users' interests.

### SUMMARY

This invention has a number of aspects. These aspects may be applied individually or in any suitable combinations. One aspect relates to tagging user devices (using cookies or otherwise) by way of interstitial web pages that establish redirections from alias URLs to destination URLs. Once a user device has been tagged information may be selectively directed to the user device. The information may be matched to or selected based on the subject matter of a resource at the destination URL. Another embodiment provides a redirection server configured to tag user devices that request alias URLs. Other aspects provide computer systems operable to serve advertisements or other information to computers of users who have used the alias URLs to access the corresponding destination URLs. The information provided may relate to subject matter related to the subject matter of the visited destination URLs.

One example non-limiting aspect of the invention provides a redirection server comprising a database that associates unique alias URLs to corresponding destination URLs and a web server configured to, in response to a request containing one of the unique alias URLs, serve an interstitial web page configured to redirect a web browser to a resource at the corresponding destination URL and to tag a user device generating the request. The redirection server may operate as a stand-alone service or may be integrated in a system with other elements such as an advertising server. The interstitial page may be configured to tag a user by one or more of placing a cookie on a user device that accesses the interstitial page or executing a script that records information identifying the user device (e.g. a fixed network address, a hardware fingerprint, an identity under which a user of the user device is signed in to a service or the like).

In some embodiments the redirection server comprises a data store containing a plurality of interstitial web pages, each of the plurality of interstitial web pages associated with a corresponding one of the alias URLs, wherein the web server is configured to, in response to receiving the request containing one of the unique alias URLs, retrieve one of the plurality of stored interstitial web pages corresponding to the one of the unique alias URLs and serve the retrieved one of the plurality of stored interstitial web pages to the web browser. In other embodiments the redirection server comprises a page builder configured to retrieve from the database: the destination URL corresponding to the alias URL and the cookie corresponding to the alias URL and to generate the interstitial web page using the retrieved destination URL and cookie. Generation of the interstitial web pages may be performed on the fly. In some embodiments some interstitial pages (e.g. interstitial pages corresponding to popular alias URLs) are made in advance and stored for access by the redirection server and others (e.g. interstitial pages corresponding to less-popular alias URLs) are created on the fly.

The redirection server may include a configuration interface comprising a field for receiving an input destination URL and a field for receiving cookie data (or a script for placing cookie data and/or retrieving ID information from a user device) wherein the redirection server is configured to associate the input destination URL with a new unique alias URL and to store and associate in the database the new unique alias URL, the destination URL and the cookie data.

The redirection server may include a facility configured to process resources identified by the destination URLs in the database to identify subject matter of the resources and to store in the database a record associating the identified subject matter (which may be in the form of concepts, keywords and/or key phrases) with the corresponding alias URLs. In an example embodiment the facility comprises web crawler software configured to access the resources and to identify concepts, keywords and/or key phrases in each of the resources.

The redirection server may be associated with an ordering interface that provides a search tool configured to search for concepts, keywords and/or key phrases represented in the database; a selection tool configured to allow a user to select one or more of the concepts, keywords and/or key phrases represented in the database and returned by the search tool; and a field for receiving an offer to be associated with the selected one or more of the concepts, keywords and/or key phrases. The ordering interface may comprise a user-selectable filter configured to cause the search tool to return for selection only concepts, keywords and/or key phrases associated with alias URLs that satisfy one or more performance criteria.

A redirection server may form a part of a system additionally comprising an information server configured to deliver information in the form of an advertisement to the browser in response to receiving notification that the browser was tagged by accessing one of the alias URLs. The notification may comprise cookie data or an ID matching an ID stored in the database. The information may be matched to the subject matter of the resource at the destination URL corresponding to the alias URL. The advertisement may, for example, comprise a banner advertisement in a web page served to the browser.

Another example aspect provides a method for automatic information delivery. The method comprises obtaining cookie data associated with information to be delivered; configuring a redirection server to associate an alias URL with: a destination URL identifying an internet-accessible resource and with the cookie data and to, in response to a request for the alias URL, serve an interstitial web page comprising a redirection to the resource at the destination URL and commands to serve the cookie data to or otherwise tag a web browser originating the request for the alias URL. The method may further comprise detecting a web browser that has been tagged by accessing the alias URL and serving information to the web browser. the information may be selected to relate to subject matter that is related to subject matter of the corresponding destination URL.

Another example aspect provides an automated method comprising: accessing a database comprising associations between alias URLs and destination URLs, each of the destination URLs identifying an internet-accessible resource to retrieve the destination URLs; using the destination URLs accessing the resources associated with the destination URLs and processing each of the resources to identify corresponding concepts, keywords and/or key phrases; and associating the alias URLs with the corresponding concepts, keywords and/or key phrases in database records. The method optionally comprises receiving offers for the concepts, keywords and/or key phrases, each of the offers associated with corresponding cookie data and associating the cookie data with each of the alias URLs that are associated with the one or more of the concepts, keywords and/or key phrases comprises identifying the greatest offer for one of the concepts, keywords and/or key phrases and associating with those of the alias URLs associated with the one of the concepts, keywords and/or key phrases the cookie data associated with the identified greatest offer.

Another example aspect provides a method for automatic information delivery, the method comprising: obtaining information to be delivered; configuring a redirection server to associate an alias URL with a destination URL identifying an internet-accessible resource; and in response to a request for the alias URL, serving an interstitial web page comprising a redirection to the resource at the destination URL and tagging a user device originating the request for the alias URL. In some embodiments the method comprises receiving cookie data associated with the information to be delivered and configuring the interstitial web page serve the cookie data to the user device.

Any of these aspects may be used to deliver relevant advertising or other information to users of cellular telephones or other mobile devices, desktop computers, portable computers or other devices that can be used to access internet resources.

Further aspects and example embodiments are illustrated in the accompanying drawings and/or described in the following description and/or set out in the accompanying claims.

### BRIEF DESCRIPTION OF THE DRAWINGS

The accompanying drawings illustrate non-limiting example embodiments of the invention.

FIG. 1 is a schematic overview of a system according to some embodiments.

FIG. 2 is a block diagram illustrating a possible construction for a redirecting server.

FIG. 2A is a schematic illustration of the exchange of information among different components of a system including a redirection server.

FIG. 3 is a schematic illustration showing an interface for setting up an alias link according to an example embodiment.

FIG. 4 is a flow chart illustrating a method that may be performed by a redirecting server.

FIG. 5 is a flow chart illustrating an example method that may be performed by a computer of a campaign organizer.

FIGS. 6A and 6B are flow charts illustrating methods that may be performed by a redirection server or by another computer system associated with a redirection server to facilitate placement of interest based information.

FIGS. 7 and 7A respectively show an apparatus that may be configured to facilitate purchasing keywords, concepts, or phrases using a highest-bid model and an interface display for the apparatus.

FIG. 8 shows examples of short URLs corresponding to longer destination URLs.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

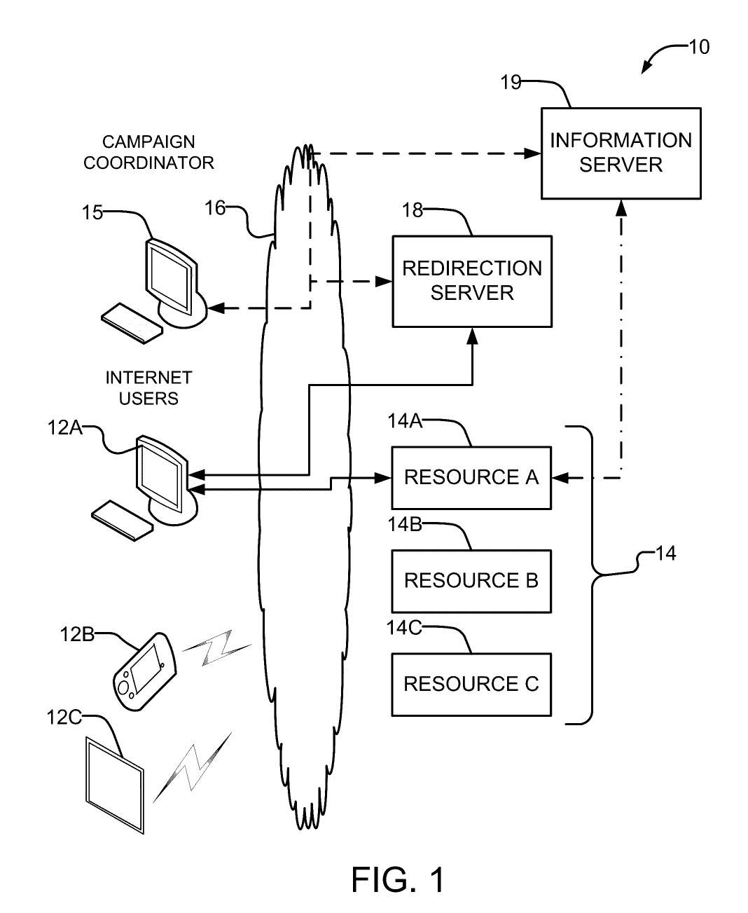

FIG. 1 shows a system 10 according to an example embodiment. System 10 includes a plurality of user devices 12 which may be used by users to access information, for example, by visiting websites or accessing other resources. User devices 12 may comprise personal computers (e.g. personal computer 12A); internet enabled mobile devices (such as smartphone 12B); or internet enabled appliances (for example internet enabled television 12C). User devices 12 may access websites or other resources 14 by way of a data communication network 16 which may, for example, comprise the internet (although the technology described herein may be applied to other data communication networks). User devices 12 may include any internet enabled devices connected to the internet, for example.

Data communication network 16 allows user devices 12 to access resources 14 using addresses for those resources. In the following discussion, resources 14 will be described as webpages. However, it is to be understood that resources 14 may also consist of or comprise resources of other types. Webpages 14A, 14B, and 14C are shown. However, resources 14 may comprise internet accessible resources of other types such as FTP resources, sources of streaming media, etc.

The addresses used on the internet to identify webpages are generally in the form of a URL. URLs are often relatively long. This makes them awkward to type and also makes them hard to fit in short messages such as tweets on Twitter™ which limits postings made by users to 140 characters.

System 10 includes a redirection server 18. A campaign organizer or another party can use a computer 15 to access redirection server 18 and to cause redirection server 18 to associate an alias URL with a destination URL corresponding to a particular corresponding resource 14. Conveniently, the alias URL may be much shorter than the URL identifying the resource 14. The alias URL identifies a resource on redirection server 18 such that requests for the alias URL are routed to redirection server 18.

The campaign organizer may also operate redirection server 18 to associate a particular script with the alias URL. This script may cause a tracking cookie to be loaded onto the devices 12 of users who use the alias URL to access the resource 14 as discussed herein. The tracking cookies may persist in the devices 12 for some time, for example, several days, a few weeks or months. In some embodiments the tracking cookies may include set expiry dates in the range of days to months after the dates that the tracking cookies are served to user devices.

While the user of a device 12 that has received a tracking cookie from redirecting server 18 is accessing a resource 14, such as a website 14A, or while the user is accessing other resources 14 (whether or not by using an alias URL serviced by redirection server 18), the website 14 may display to the user information from an information server 19. The information server 19 may use the tracking cookie to determine what information to provide to the user. The information may, for example, be included in banner advertisements provided by the website 14. In some embodiments, website 14 is configured to retrieve one or more cookies from the computer of a user who is accessing a webpage of website 14. The website may identify a cookie as being associated with information server 19. In response, the website 14 may forward the cookie to information server 19. Information server 19 may process the cookie and return information for display associated with the cookie.

In some embodiments information server 19 is a server of an advertising network. The advertising network may cooperate with many web sites or other resources 14. These web sites or other resources may be configured to cause cookies or other tracking information from user devices 12 to be delivered to information server 19. Information server 19 may then select based on the cookies or other tracking information and provide information such as banner advertisements to be displayed on the user devices 12.

In some embodiments cookies are included in interstitial web pages only if the corresponding URL satisfies some performance criterion. For example, redirection server 18 may track the rate at which it receives requests for a particular alias URL and may place cookies on interstitial pages corresponding to that alias URL only if the alias URL has, for example, been requested at least a threshold number or times and/or the alias URL is being requested at a threshold rate (e.g. at least a certain number of requests per hour or per day). In cases where the alias URL does not meet the performance criterion such embodiments may not place cookies or perform tagging of user devices by way of the corresponding interstitial page.

As an alternative or in addition to placing cookies on user devices 12 using interstitial pages, a redirection server as described herein may record an association between a characteristic that is specific to a user device 12 in response to a request for an alias link originating from that user device 12. This characteristic may be acquired using a script included in the interstitial page or using information that is received from a user device 12 with a request for an alias URL. For example, a script in an interstitial web page may cause a user device to communicate to redirection server 18 a static network address (e.g. an internet protocol version 6 or “IPv6” address) for the user device 12 or a fingerprint representing a configuration (hardware and/or software) of aspects of the user device 12 (e.g. a HTML5 canvas fingerprint or other fingerprint—a range of fingerprinting technologies operable to associate an anonymous fingerprint to a particular device are commercially available and may be used to obtain a fingerprint suitable for the present application) and/or an ID provided in a hardware device, a cryptographic certificate or the like held by the user device 12. In response to receiving such information from the user device 12, redirection server 18 may store and maintain an association in a database between the characteristic(s) of the user device (which may generally be called an ‘ID characteristic’) and the corresponding alias URL.

The association between an ID characteristic for a user device 12 and an alias URL may be used by an information server 19 to deliver relevant information to the user device 12 as the user device 12 accesses web pages or other resources on the internet. For example, the information server 19 may receive ID characteristics for user devices 12 that access various resources 14. The ID characteristics may be provided, for example, by scripts which execute on the browser of a user device 12 when the user device 12 accesses resources 14. Upon receipt of an ID characteristic, information server 19 may search the database to determine whether the ID characteristic is present in the database and, if so, what alias URLs it is associated with. Information server 19 may then apply a rule to identify information to be delivered to the user device 12 in the form of a banner advertisement or another form. The rule may comprise searching the database to find information (e.g. advertisements) associated with alias URLs.

If a plurality of alias URLs are all associated with a particular user device 12 or if a plurality of different advertisements or other information are all associated with one alias URL then the rule may cause information server 18 to select one qualifying advertisement or other information to be delivered to the user device 12. For example, the rule may cause the information server 18 to:
select among two or more of the qualifying advertisements or other information of the plurality of possibilities based on offered amounts for delivering the advertising or other information (e.g. selecting the advertising or other information for which the offered amount is greatest);
select among two or more of the qualifying advertisements or other information at random;
select among two or more of the qualifying advertisements or other information based on a priority order; or
any combination of these.

An advantage of system 10 from the point of view of the operator of computer 15 is that users of devices 12 will generally only follow an alias URL if they are interested in the content of the resource 14 identified by the alias URL. Consequently, there is a strong indication that each user who actuates an alias URL, and thereby receives a cookie from redirection server 18 or causes their user device 12 to be tagged in another manner by redirection server 18, has a particular interest in the subject matter of the content in the resource 14 associated with the alias URL. Consequently, information server 19 may be configured to deliver information to users that is tailored to the users' interests as determined by the cookies or tags provided by redirecting server 18 which are, in turn, associated with particular resources 14. A campaign organizer using computer 15 may provide advertisements or other information to information server 19 for delivery to such users.

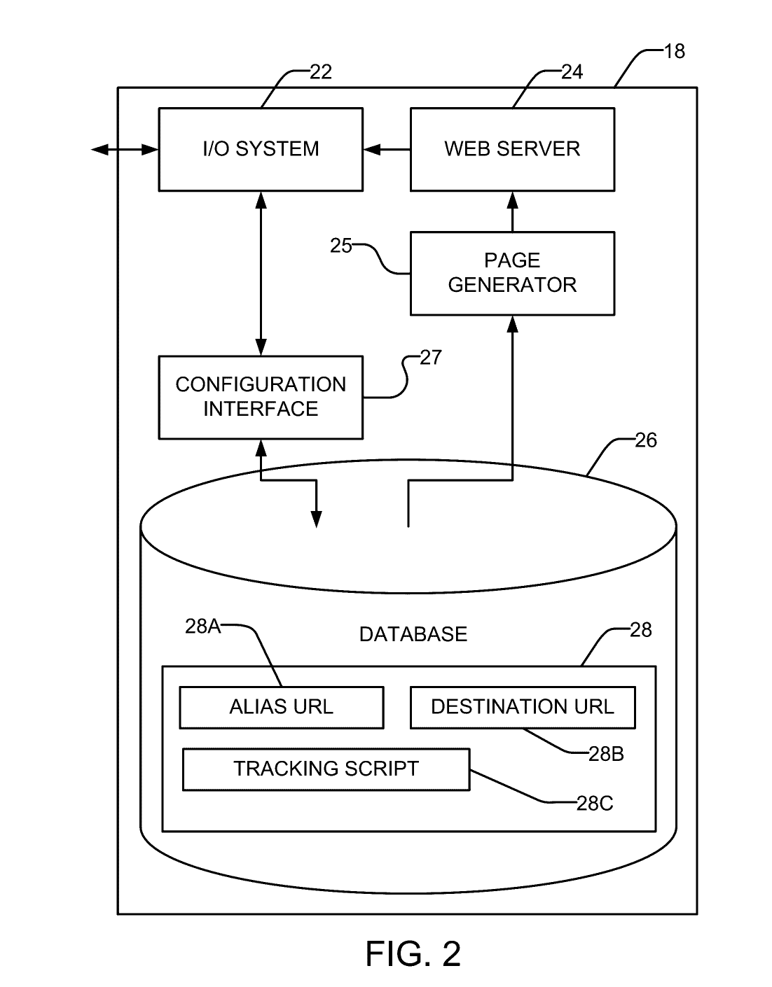

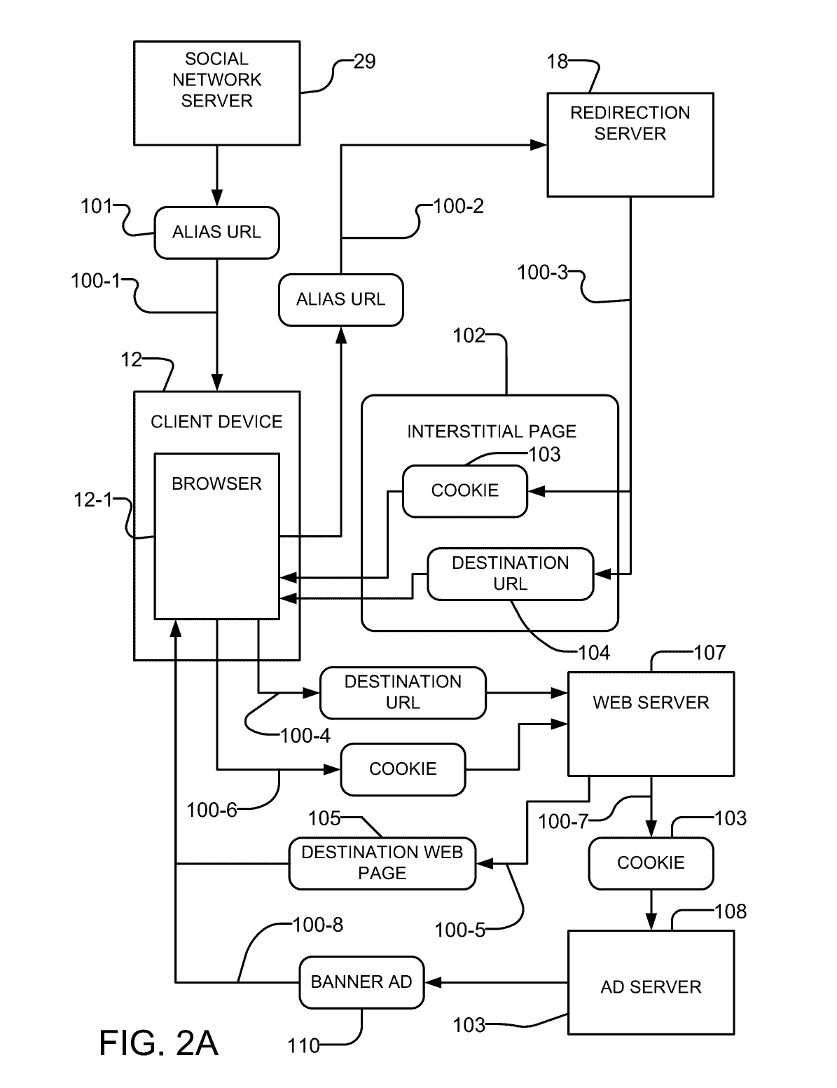

FIG. 2 is a block diagram illustrating an example construction of a redirection server 18. Redirection server 18 includes a communication interface that carries two way data communication to and from redirection server 18. Redirection server 18 also includes a web server 24 which responds to requests for webpages corresponding to alias URLs. Web server 24 may maintain a web page corresponding to each of the alias URLs and retrieve the web pages in response to requests for the alias URLs and/or create such web pages on the fly.

In the FIG. 2 embodiment, webpages are created on the fly based on information in a database 26 by a webpage generator 25. Database 26 includes a data structure 28. Data structure 28 associates an alias URL 28A with a destination URL 28B. Data structure 28 also associates the alias URL with a tracking script 28C. In response to a request for a webpage corresponding to a particular alias URL, page generator 25 retrieves the corresponding destination URL 28B and the tracking script 28C from database 26. Page generator 25 generates a webpage that contains the tracking script 28C and a web redirection command that causes the user's web browser to be redirected to the destination URL after execution of the tracking script 28C. The redirection command may be of various forms. In some embodiments the redirection command is a HTTP redirection command. In other embodiments the redirection command is provided as a script in a scripting language supported by the browser. Any suitable redirection method may be implemented as long as the redirection method accommodates tagging user devices 12 for example by using cookies and/or by recording ID characteristics of the user devices 12.

Tracking script 28C causes a cookie to be loaded onto the browser of the computer that requested the webpage corresponding to the alias URL. Script 28C may comprise, for example, a CGI script, a PHP script, a Set-Cookie HTTP header included in a HTTP response, or other suitable configuration which causes the desired cookie data to be supplied as a cookie to the browser requesting the alias URL.

The generated webpage may be an interstitial webpage that only contains information informing a user of the redirection. The interstitial webpage may optionally comprise a link to the destination URL that may be actuated by a user of a device 12 in case automatic redirection is not completed for some reason. The interstitial web page may be a blank page that contains no displayable content.

The user of a computer 12 who has followed an alias URL may not perceive the interstitial webpage generated by redirection server 18 at all. The user may simply experience being delivered directly to the resource 14 identified by the destination URL 28B. In some embodiments the interstitial web page is displayed for 3 seconds or less or 1 second or less on a user device 12. In some embodiments the interstitial web page does not display any content on the user device 12.

Redirection server 18 also includes a configuration interface 27 which enables users such as a campaign organizer accessing configuration interface 27 from computer 15 to obtain alias URLs corresponding to particular destination URLs for resources 14. Configuration interface 27 may interact with database 26 to automatically generate unique alias URLs or to verify that a user's choice of a custom or “vanity” alias URL is unique as compared to all of the alias URLs 28A already present in database 26. In some embodiments, database 26 may contain thousands, tens of thousands, or even millions or billions of alias URLs.

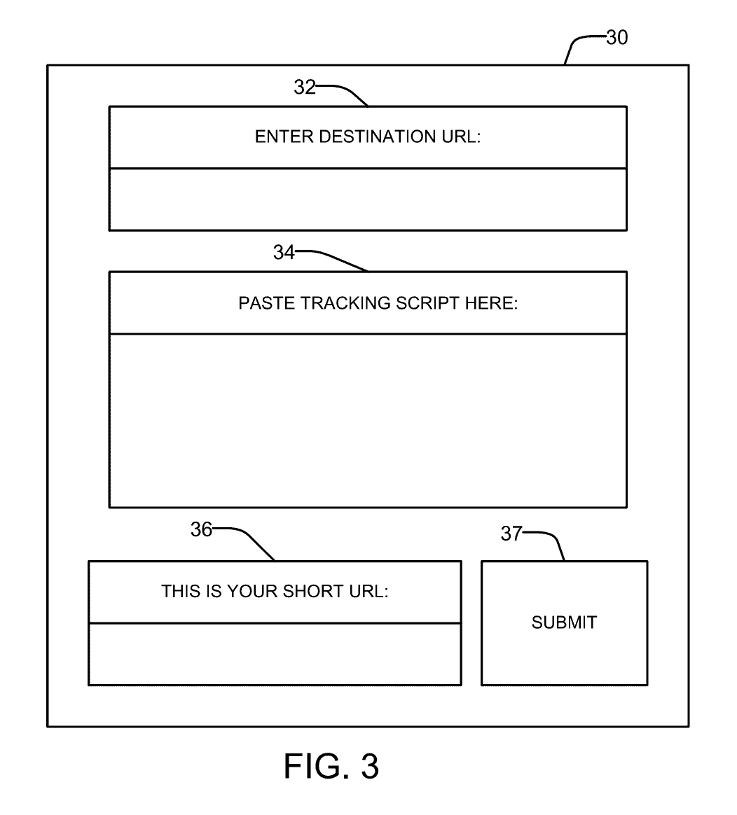

FIG. 3 shows an example graphical interface 30 that may be presented by configuration interface 27. Graphical interface 30 may, for example, be provided by a webpage, app, application, or the like. Interface 30 includes a field for receiving a destination URL for a resource 14 that a user wishes to identify. A second field 34 is provided for the alias URL (or “short URL”) corresponding to the destination URL. In different embodiments, the contents of field 34 are generated by redirection server 18 or are entered by a user. In any event, each alias URL is unique. Destination URLs are not necessarily unique. It is possible for two or more different alias URLs to identify the same destination URL.

Interface 30 also includes a window 36 into which a user can paste a tracking script. The tracking script may be generated, for example, by a third party service that the user has engaged to track and serve information content to users who have received cookies. The tracking script may contain hypertext transfer protocol (http) or other instructions which will cause a cookie to be stored in a user's computer when the user accesses the alias URL provided in field 34. Once the user has entered the destination URL in field 32 and entered a tracking script into field 36 (unless a tracking script is automatically provided by redirection server 18) and optionally entered an acceptable unique short URL into field 34 (unless redirection server 18 is configured to automatically generate unique short URLs), the user can actuate control 37. Actuating control 37 may cause a new record 28 to be generated in database 26 associating the alias URL from field 34, the destination URL from field 32, and the tracking script from field 36.

In some embodiments redirection server 18 generates a unique short URL made up of randomly or quasi-randomly chosen characters and/or of characters according to a predetermined sequence. In embodiments where the short URL is generated by redirection server 18 it is not required that the short URL be created or made known to a user prior to actuation of control 37.

FIG. 2A shows an example information flow in an example embodiment. Client device 12 receives an alias URL 101 from a social network, blog, or email server 29. Alias URL 101 may be embedded in another message such as an email message, a tweet, a blog posting, or the like. The receipt of alias URL 101 is indicated by line 100-1. Client device 12 has a browser 12-1. At some point, a user of client device 12 decides to view the resource corresponding to alias URL 101. For example, the user may read the text of a message accompanying the alias URL 101. That text may describe the subject matter of the resource pointed to by alias URL 101. Upon actuating the alias URL 101, browser 12-1 of client device 12 forwards the alias URL 101 to redirection server 18 as indicated by line 100-2. As indicated by line 100-3, redirection server 18 returns an interstitial webpage 102 comprising a cookie 103 (or other tracking mechanism) and a destination URL 104 corresponding to alias URL 101. Interstitial page 102 is processed by browser 12-1 which automatically redirects to the resource corresponding to destination URL 104 which is hosted on a web server 107. This is indicated by line 100-4.

Web server 107 returns with destination webpage 105 as indicated by line 100-5. Destination webpage 105 may optionally request cookies from browser 12-1. If this occurs, browser 12-1 may respond by returning cookie 103 to web server 107 as indicated by line 100-6. Web server 107 then forwards cookie 103 to an ad server 108 as indicated by line 100-7. Ad server 108 responds by sending a banner ad 110 which corresponds to cookie 103 to client device 12 as indicated by line 100-8.

The portion of data flow beginning at line 100-4 may be repeated for different resources 14 as a user of a user device 12 continues to access various internet resources 14. For example, a user of user device 12 may browse to internet web pages at various times subsequent to placement of cookie 103 by clicking on links. These links may be unrelated to destination web page 105. Where the user interacts with resources 14 that are configured to retrieve cookie 103 from browser 12-1 and to serve information in response to the presence of cookie 103 then the user device 12 may receive relevant information from ad server 108 (e.g. in the form of banner advertisements) by way of lines 100-6, 100-7 and 100-8. This may continue over a period of days to months (e.g. until cookie 103 or other tagging of the user device 12 expires).

Where user device 12 is tagged in some manner other than by a cookie 103 (for example where redirection server 18 has associated an alias URL with an ID characteristic of the user device 12) then, as the user subsequently interacts with internet resources 14, some of those resources may be configured to obtain the ID characteristic from the user device 12 and to use that ID characteristic and the alias URL(s) with which the ID characteristic has been associated by redirection server 18 to select and deliver to the user device 12 advertisements or other information.

In different embodiments, the interaction between a web server 107 serving a web page and ad server 108 may be different. Communications from ad server 108 to client device 12 may be through web server 107. In other embodiments, a webpage causes cookie 103 to be sent directly to advertising server 108 instead of by way of web server 107. In either case, viewing of a webpage served by web server 107 (or some other web server) causes directly or indirectly ad server 108 to serve to client device 12 information corresponding to cookie 103 that was included in interstitial page 102.

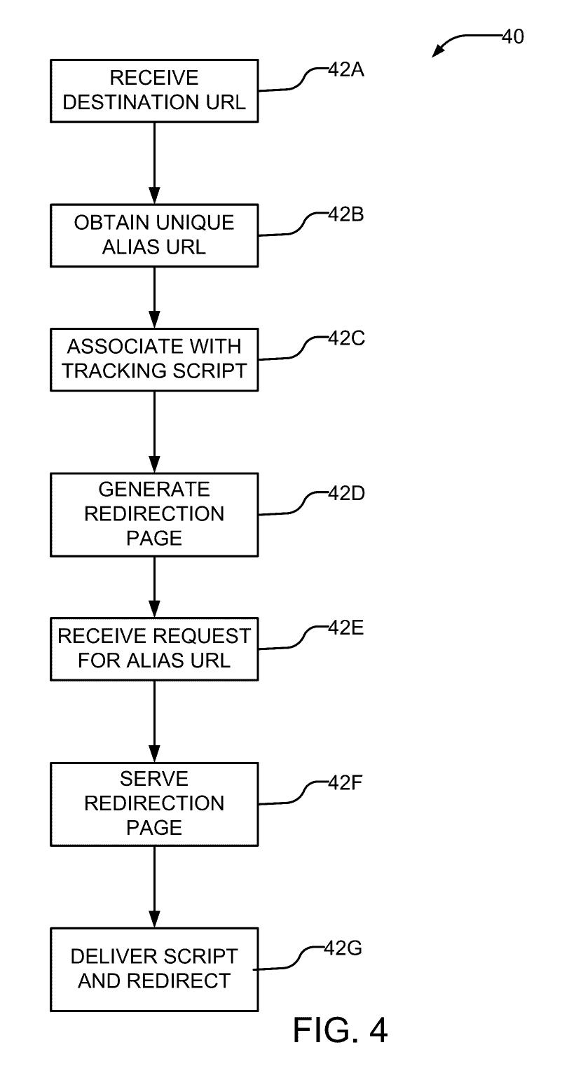

FIG. 4 illustrates a method 40 that may be performed at a redirection server 18. The order of the blocks in FIG. 4 may be varied without departing from the general concept. In block 42A redirection server 18 receives a destination URL identifying a resource 14 such as a website. In block 42B redirection server 18 obtains a unique alias URL that it may associate with the destination URL received in block 42A. Block 42B may comprise receiving a suggested alias URL from a user and checking a database to verify that the suggested alias URL is unique or automatically generating a new alias URL that is unique in comparison to other alias URLs being maintained by the redirection server 18. In block 42C, the alias URL generated in block 42B is associated with a tracking script. As noted above, block 42C may comprise receiving a user input of a tracking script or generating a tracking script for the user. In other embodiments, block 42C comprises receiving data for a cookie. The redirection server 18 may generate or store a script suitable for delivering a cookie containing the cookie data to users of devices 12 or for otherwise tagging user devices 12 and associating the tags with the alias URL.

In block 42D a redirection webpage is generated. The redirection webpage includes commands to redirect the browser from the alias URL to the corresponding destination URL and also includes the tracking script associated with the alias URL in block 42C.

In block 42E the redirection server receives a request for the alias URL from a user of a device 12. In response, in block 42F redirection server 18 serves the redirection webpage generated in block 42D. Serving the webpage includes delivering the tracking script and the redirect commands to a user device 12 as indicated in block 42G. The user device 12 is then marked with a cookie supplied by the tracking script or is otherwise tagged and is automatically redirected to the resource 14 identified by the destination URL received in block 42A. Where redirect webpages are created on the fly, the order of blocks 42E and 42F may be reversed. Also, blocks 42A, 42B, and 42C may be performed in any order.

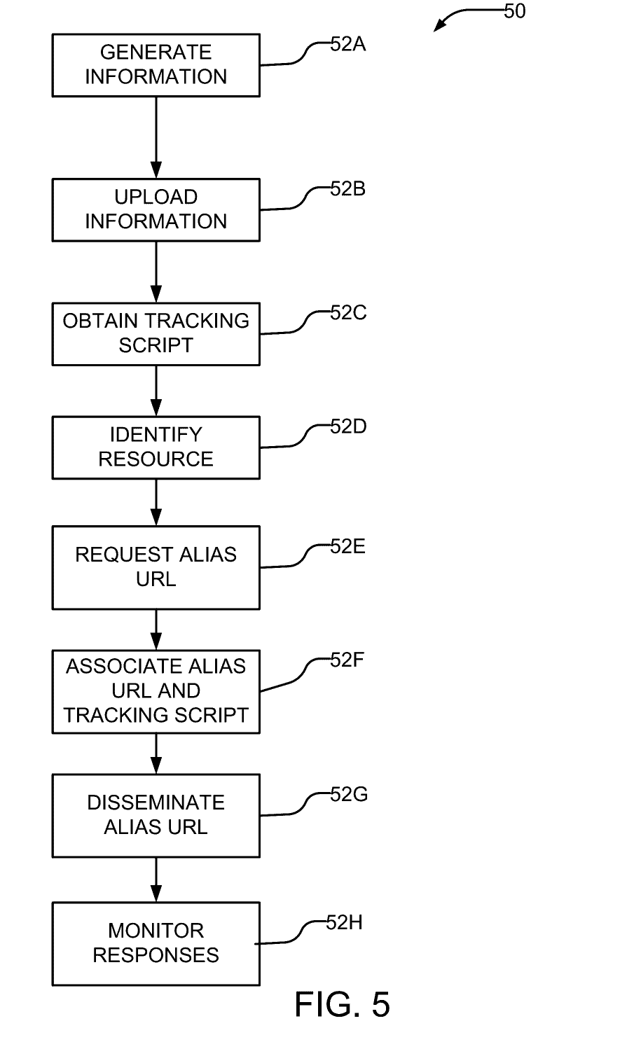

FIG. 5 is a flow chart illustrating a method 50 that may be performed by a campaign organizer (who may be an individual or a group) who wishes to disseminate advertisements or other information to selected users who are interested in particular topics. At block 52A, the campaign organizer generates information for delivery to the users of computers 12. The information may, for example, comprise advertisements, news, comments, blogs or other information, which may be provided in the form of text, images, animated images, videos, or the like. In block 52B the information is uploaded to information server 19. In block 52C the campaign organizer obtains a tracking script. The tracking script may, for example, be provided by the information server 19. In block 52D the campaign organizer identifies a resource 14 that would be very interesting to the type of people who may also be interested in the information uploaded in block 52D. In block 52E, redirection server 18 is accessed to request an alias URL for the resource identified in block 52D. In block 52F the tracking script obtained in block 52C is associated with the alias URL. In block 52G the campaign organizer disseminates the alias URL in any suitable manner. For example, the alias URL may be disseminated in emails, in tweets delivered via Twitter™, Hootsuite™, Buffer™, Sprinkler™, on webpages, in blog posts, or the like.

In block 52H the campaign organizer may log on to information server 19 to monitor the level of responses received. For example, how many users actuated the alias URLs? Where are they coming from? Which device or browser are they using etc.? Of those users, how many viewed each item of information uploaded in block 52B? Of those, how many users interacted with the uploaded information (for example, by clicking on it)? Of those that clicked in the advertising, how many have gone on to purchase the product sold by the advertiser online? etc.

The functions of redirection server 18 and information server 19 may be separated, as illustrated in FIG. 1. In other embodiments, these components are combined together in a single system. Whether redirection server 18 and information server 19 are separate or combined, once a number of alias URLs have been created in redirection server 18, it is possible for the operator of information server 19 to deliver or coordinate delivery of information to users who have actuated alias URLs which was not necessarily provided by the same entity that created the alias URLs. Furthermore, in such embodiments, it is not necessary for the creator of an alias URL to supply a tracking script. In some embodiments, the tracking script is provided by the operator of redirection server 18. The party requesting that redirection server 18 associate an alias URL with a particular destination URL does not need to have any involvement in the tracking scripts used by redirection server 18. Furthermore, the operator of redirection server 18 may provide the service of identifying users who have particular interests (as expressed by the users having followed alias URLs). Others who wish to deliver such information to such users may purchase access to the users' devices 12 either on a fixed price basis, an auction basis, a lottery basis, or the like.

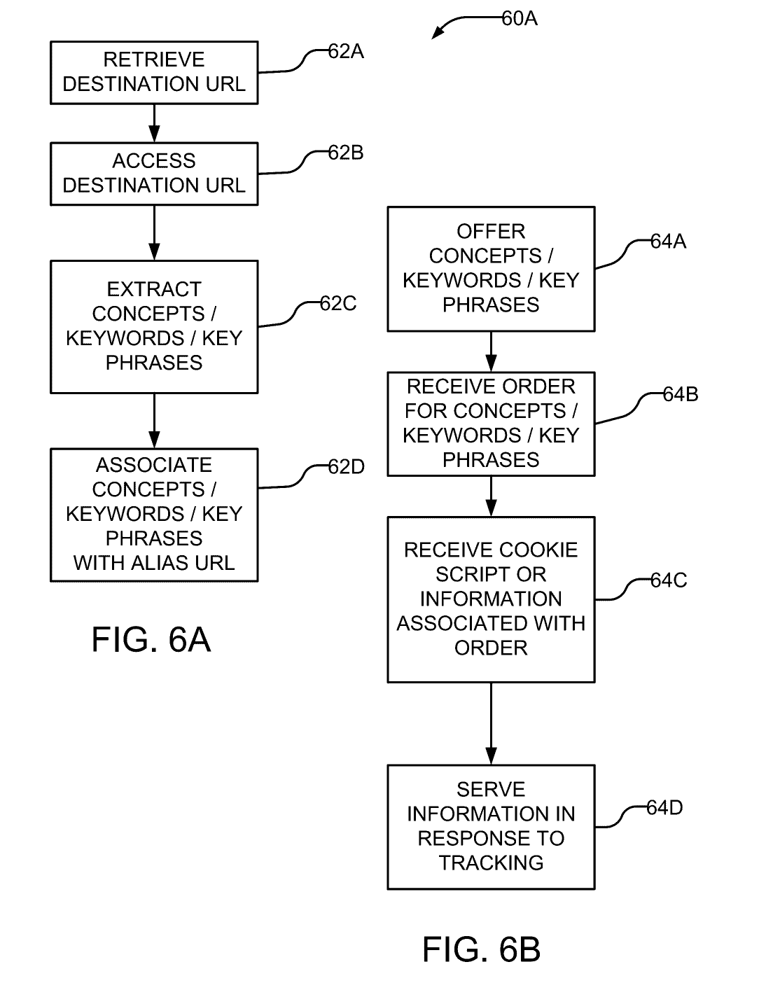

FIG. 6A is a flow chart illustrating a method 60A that may be performed at or using information in redirection server 18. Method 60 begins at block 62A with receiving a destination URL from database 26. At block 62B, the destination URL is accessed. At block 62C keywords and concepts are extracted from the resource identified by the destination URL. Extracting keywords and concepts from the resource may comprise, for example, indexing words present in the text of a website or other resource, selecting significant words and phrases present in a website or other resource (e.g. by ignoring common words), parsing the text of a website or other resource, identifying words that occur most commonly in the text of a website or other resource, identifying words that are most relevant to the website or other resource, and/or identifying whether words in a website or other resource have positive or negative connotations, and so on. Various techniques for processing blocks of text to identify the most relevant words and phrases in the blocks of text are known in the art and may be applied in implementations of the present invention. Tools for extracting concepts, keywords and/or key phrases from the text of websites are commercially available. Some embodiments apply one or more of such tools to extract concepts, keywords and/or key phrases from resources 14 identified by destination URLs. Web crawler software may be used to automatically visit resources corresponding to alias URLs and to extract information that characterizes the resources.

In block 62D the identified concepts, keywords, and/or concepts are added to a database and associated with the alias URL.

As discussed above, when users of computers 12 access a destination URL using any of the alias URLs then cookies may be placed on their devices or the devices may be tagged in some other way—e.g. by collecting an anonymous ID characteristic and associating that ID characteristic with an alias URL as described elsewhere herein. Such cookies or collected ID characteristics may identify that the users have accessed the particular destination URL in question. Parties who wish to disseminate advertisements or other information may find it valuable to disseminate information to persons who have expressed a particular interest in the area to which the information relates.

FIG. 6B illustrates a method 60B that may be performed after the concepts, keywords, and phrases have been identified by method 60A. Method 60B involves offering concepts, keywords, and/or phrases from among those identified in method 60A to advertisers or other disseminators of information. For example, an advertiser may search the database of concepts, keywords, and phrases generated in block 62D to find concepts, keywords, and/or phrases that would be of interest to their intended audience.

In some embodiments the system is configured to search the database of concepts, keywords and/or key phrases for concepts, keywords and/or key phrases similar to those that a user is searching for and to provide results of such searches as suggestions of other similar concepts, keywords and/or key phrases. For example, if a user searches for links that redirect to pages that contain “social media” in block 64A, the system may suggest “social media strategies”, “social media marketing” etc. if those phrases are in the database.

In some embodiments the system provides users with additional information regarding links that are associated with concepts/keywords and/or key phrases. For example, the system may also provide one or more of:
a score indicating how relevant a selected keyword is to the destination resource 14,
how many clicks have been performed in the short (alias) URL,
click trends for the short (alias) URL, and/or
how many clicks on the short (alias) URL are predicted in a particular time window (e.g. the next day, week etc.).

In some embodiments the search for concepts, keywords and/or key phrases includes a filter function that allows users to exclude concepts, keywords and/or key phrases for which the corresponding alias URLs do not satisfy one or more filter criteria. The filter criteria may, for example, include criteria that relate to how often the alias URLs are being followed. In some embodiments only concepts, keywords and/or key phrases for which the corresponding alias URLs are being clicked at a certain rate are included in the search results. In some embodiments the filter criteria are user-selectable.

In block 64B an order is received to place information corresponding to particular concepts, keywords, and/or phrases. In block 64C the information associated with the order of block 64B is received. In block 64D the information is served to computer users who have used the alias URLs to access resources 14 which are associated with the selected concepts, keywords, and/or phrases.

In some embodiments, additional alias URLs may be created after an order has been placed to tag user devices (by way of cookies or otherwise) which activate alias URLs corresponding to certain selected concepts, keywords and/or key phrases. Redirection server 18 may automatically extend the order to those of the additional alias URLs which correspond to the selected concepts, keywords and/or key phrases. In some embodiments, each time an alias URL is added, redirection server 18 automatically accesses the resource at the corresponding destination URL and processes the resource to obtain corresponding concepts, keywords and/or key phrases.

Method 60B may be used to place advertisements or other information in webpages viewed by users who have actuated alias URLs. Further, that information may be selectively displayed to users who have indicated their interest in particular subject matter related to the information by actuating particular ones of the alias URLs.

In another embodiment, cookies for inclusion in the interstitial webpages created by redirection server 18 may be supplied by others and/or tagging information (such as ID characteristics for user devices that have accessed the alias URL) may be provided to the others. For example, an advertiser may pay the operator of redirection server 18 to insert the advertiser's cookies into interstitial webpages corresponding to selected alias URLs (e.g. alias URLs for which the corresponding resource 14 ranks highly for particular concepts, keywords, and/or key phrases and optionally for which the alias URLs also satisfy one or more performance criteria). In such embodiments, redirection server 18 may comprise an interface which allows different advertisers to upload their cookies (or tracking scripts) as well as an offer to pay a certain amount for each placement of a cookie. The redirection server may automatically insert the cookies of the advertiser who is willing to pay the most for placed cookies at a given time. For example, the successful advertiser may be identified by a bidding process.

For example, a first advertiser of products relevant to parents of newborns may offer a certain amount for each cookie placement in interstitial webpages that redirect to resources on topics related to feeding infants (e.g. as indicated by concepts, keywords, and/or key phrases). For some time, redirection server 18 may place cookies for the first advertiser in such interstitial web pages. Subsequently, a second advertiser may offer a higher amount for each cookie placement in the same interstitial web pages. Redirection server 18 may then automatically switch to placing cookies from the second advertiser. As noted above, each cookie may persist in a user device 12 for some time. During that time information may automatically be provided to the user device 12 when the user device 12 connects to internet resources 14 (whether or not those resources 14 are known to redirection server 18).

In some embodiments advertisers may set budgets as well as offers. For example, redirection server 18 may record that a particular advertiser has offered $2.00 for each placement of a cookie in an interstitial page for a particular link. Redirection server 18 may also record that the advertiser has a budget of $100 for such placements. In such embodiments redirection server 18 may continue to place the advertiser's cookie into interstitial pages for that link until the budget has been exhausted (i.e. in this example, after 50 cookies have been placed). In some embodiments redirection server may contact the advertiser automatically when a budget has been reached or is almost reached. This may be done, for example using automatically generated electronic messages such as text messages, emails, tweets, automated telephone calls or the like.

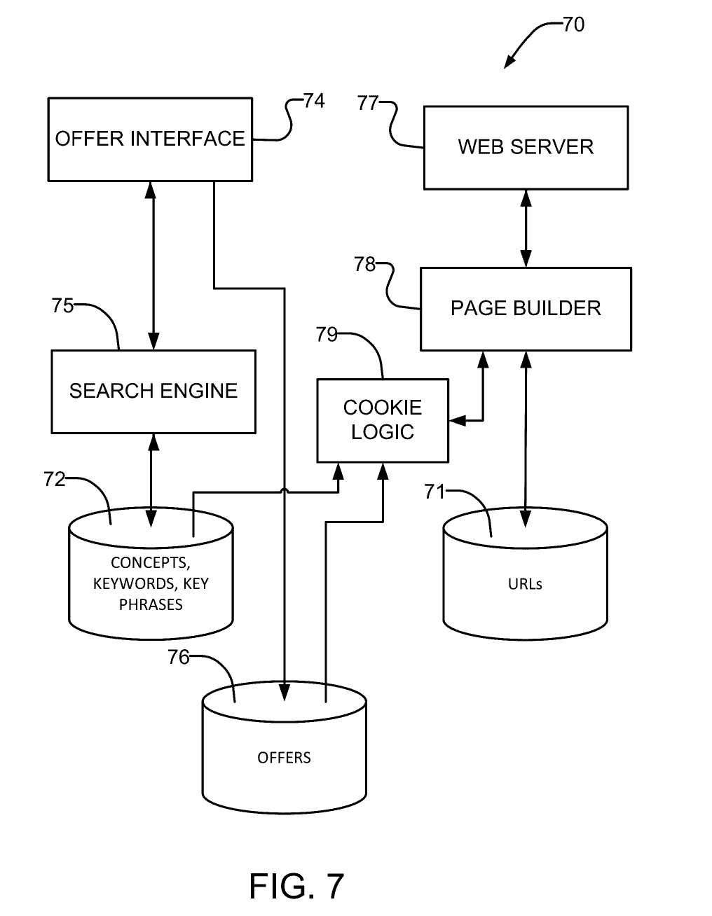

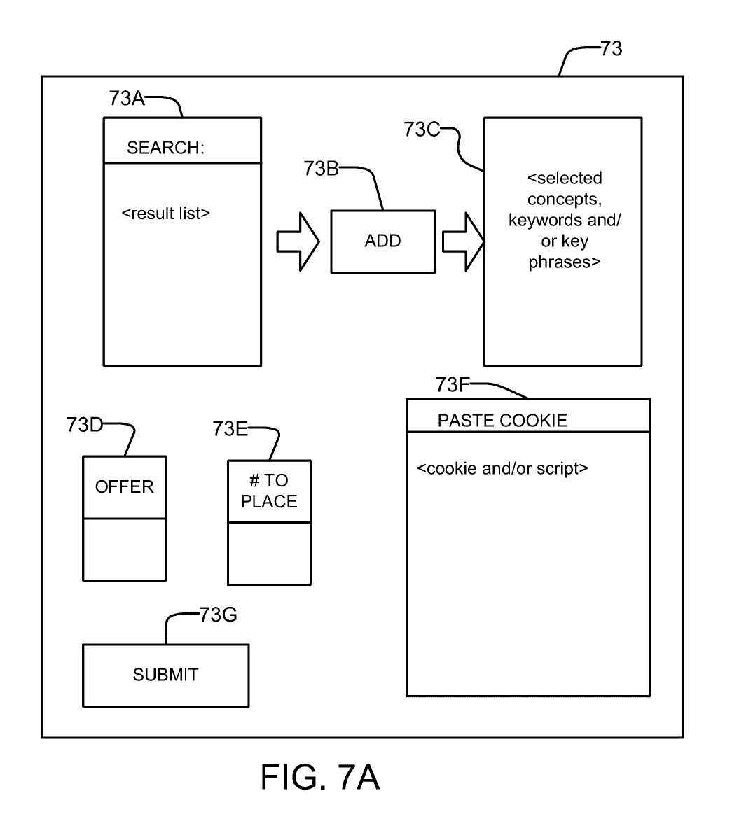

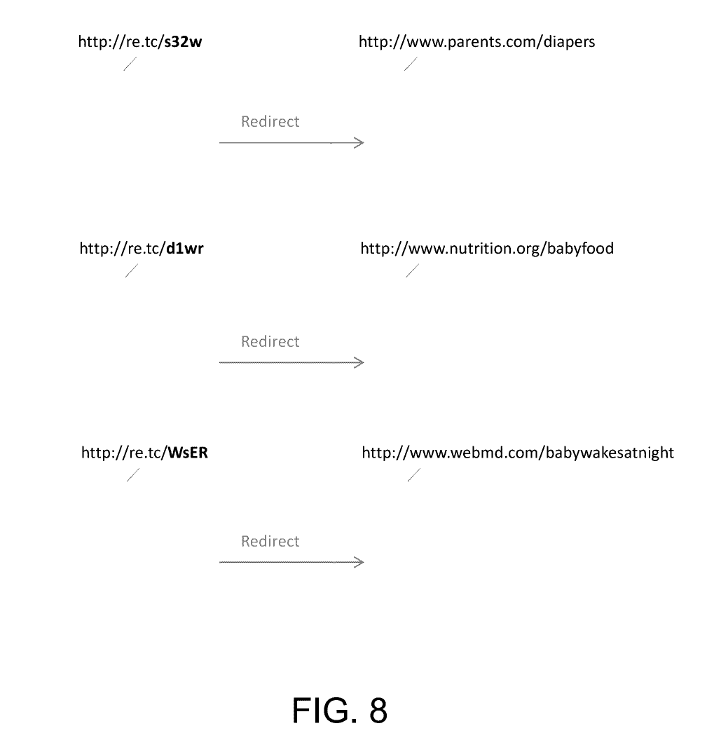

FIG. 7 illustrates a system 70 that includes a component which places cookies by way of interstitial webpages as described herein. System 70 includes a database 72 containing concepts, keywords, and/or key phrases associated with the resources linked to by alias URLs. System 70 also comprises an interface 74 configured to accept from advertisers offers for placing cookies by way of interstitial webpages for alias URLs for resources including specific concepts, keywords, and/or key phrases.

FIG. 7A shows a very simple example interface display 73 which may be provided by interface 74. Display 73 includes a window 73A for searching for concepts, keywords, and/or key phrases in database 74 by way of search engine 75, a control 73B operable for selecting concepts found in window 73A, a window 73C containing selected concepts, keywords, and/or key phrases, a field 73D for a price to be paid for insertions of cookies, a field 73E for a number of insertions desired, and a field 73F for receiving cookie data and/or a tracking script.

System 70 includes a database 76 that contains offers for concepts, keywords, and phrases received via interface 74.

When a request for an alias URL is received at web server 77, a webpage generator 78 receives the corresponding destination URL from database 71. Cookie logic system 79 checks database 72 for concepts, keywords, and/or key phrases associated with the alias URL and checks database 76 for any offers relating to those concepts, keywords, and/or key phrases. Cookie logic system 79 retrieves the cookies for the highest offer, if any, and passes the cookie to webpage generator 78 that creates an interstitial page containing a redirection to the destination URL and the cookie provided by cookie logic 79.

Although databases 71 72 and 76 are illustrated as being separate from one another the functions of two or more of databases 71, 72 and 76 (or any other databases described herein) may be combined in any suitable manner that permits sufficiently efficient retrieval of the required information.

Systems as described herein may maintain statistics which facilitate payments. For example, the systems may track:
the number of cookies placed;
the number of views of banner adds or other information displayed as a result of cookies of other tagging as described herein;
the number of click-throughs of banner adds or other information displayed as a result of cookies of other tagging as described herein;
the number of times an alias URL is activated.

Such systems may be set up to automatically charge advertisers for displaying information at user devices 12 based on any suitable payment model (pay per view and pay per click being two examples). Such systems may optionally automatically reward those who create popular alias URLs by making payments based on some measure of the popularity of the alias URLs and/or the amount of revenue obtained through the tagging of user devices that have requested the alias URLs.

In some embodiments, the functions of a redirection server 18 are provided by a system which also provides functions of one or more of an information server 19, and ad server 108, a social network server 29, and a web server 107.

### Application Example

A manufacturer of accessories for use with high-end audiophile sound systems wishes to provide advertisements relating to those accessories to people who are particularly interested in high-end audiophile sound systems. The manufacturer identifies some excellent articles containing information on the topic of high-end audiophile sound systems and uses a redirection server 18 to create alias URLs for those articles as described above. The user also creates an account with a third party tracking and advertising service. The user receives a tracking script from the third party advertising service and associates that tracking script with the alias URLs as described above. The manufacturer also uploads advertisements for its accessories to an advertising server 19 operated by the advertising service.

The manufacturer writes an article on its home webpage and includes the alias URLs in its articles. The manufacturer also contributes to a blog on a third party website and includes the alias URLs in various blog postings. The manufacturer also has a Twitter account and puts out tweets which include the alias URLs. The advertiser may also redirect its readers to a third party site that contains third party content that the manufacturer believes will be of interest to his target group and has a high likelihood of being clicked by them.

As a result of these actions, the alias URLs are made available to internet users. Some internet users may send the alias URLs to others, for example, by retweeting them, posting them in their own blogs or by email. As a result, a large number of people may have access to the alias URLs creating a viral spread of the alias URLs among users that share a common interest and are thus interesting targets for the manufacturer. Those who are interested in the subject matter of the resources referenced by the alias URLs (high-end audiophile sound systems) may actuate the alias URLs and read the articles at the webpages of the corresponding destination URLs. In the course of doing so, the computers of each of these users receive a cookie. As the users subsequently visit various websites, the cookie may be uploaded and forwarded to the third party advertising server who may then serve the advertisements uploaded by the manufacturer to those users. The manufacturer may be willing to pay a premium price for those advertisements because the manufacturer knows in advance that they will be delivered selectively to people who have a particular interest in high-end audiophile sound systems as evidenced by their following the alias URL.

### Second Example Application

In another embodiment, a wide range of individuals may use a redirection server 18 simply for the convenience of being able to provide shortened URLs that they can use to direct their friends, colleagues, or others to particular resources of interest. Redirection server 18 examines the resources identified by the destination URLs and extracts concepts, keywords, and/or phrases which represent the subject matter to which those destination URLs are directed (e.g. using the method 60A of FIG. 6). The manufacturer of accessories for high-end audio systems described above, wishes to deliver advertisements for their accessories to people who are interested in high-end audiophile sound systems. To this end, the manufacturer searches the database of concepts, keywords, and/or phrases to identify concepts, keywords, and/or phrases that would signify a strong connection with high-end audiophile sound systems. These may include brand names of audiophile components, words (such as “audiophile”), as well as technical terms that indicate an association with this subject matter (such as “high end audio systems” or “premium audio devices” etc). The manufacturer may provide cookie data or a tracking script or advertisements, and payment for having cookies placed and those advertisements delivered to users who have actuated the alias URLs corresponding to resources with which the selected keywords, concepts, and/or phrases are associated. In this manner, the manufacturer may feel confident that their advertisements are being directed to people who are potentially interested in their products.

In this example the operator of redirection server 18 may make payments to those who create alias URLs that result in revenue to the operator of redirection server 18. This encourages users to create links to interesting resources 14.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Words that indicate association of two entities (such as an alias URL with an ID characteristic or a cookie or the association between a concept, key word or key phrase and an alias URL) include both direct and indirect associations. In a direct association a database may associate the two entities directly with one another. In an indirect association the two entities may be associated by way of intermediate entities. For example, a concept, keyword or key phrase may be indirectly associated with an alias URL by being associated with a destination page which is, in turn, associated with the alias URL.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in an internet server facility for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel. A server may comprise a single computer system having a processor, a program store containing software instructions causing the server to perform the required functions and a database. In other embodiments a server is provided by a plurality of cooperating computers that are collectively programmed to provide the functions of the server.

While processes or blocks are presented in a given order in the foregoing examples, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Systems as described herein may be accessed by way of servers, workstations, personal computers, tablet computers, PDAs, displays (such as televisions), internet appliances, hand-held devices (including personal digital assistants (PDAs)), wearable computers, all manner of cellular or mobile phones, multi-processor systems, microprocessor-based or programmable consumer electronics, network PCs, mini-computers, mainframe computers, and other devices suitable for the purposes described herein. For example, a “user computer” or “user device” may comprise any of these devices.

The invention may also be provided in the form of a program product. The program product may comprise any non-transitory medium which carries a set of computer-readable instructions which, when executed by a data processor, cause the data processor to execute a method of the invention (e.g. to operate a redirection server as described herein). Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A redirection server comprising:
a database that associates unique alias URLs to corresponding destination URLs;
a web server configured to, in response to a request containing one of the unique alias URLs, serve an interstitial web page configured to redirect a web browser to a resource at the corresponding destination URL and to tag a user device generating the request.

2. A redirection server according to claim 1 wherein the interstitial web page is configured to serve a cookie associated with the alias URL to the web browser.

3. A redirection server according to claim 1 wherein the interstitial web page is configured to obtain one or more ID characteristics from the user device.

4. A redirection server according to claim 1 comprising a data store containing a plurality of interstitial web pages, each of the plurality of interstitial web pages associated with a corresponding one of the alias URLs, wherein the web server is configured to, in response to receiving the request containing one of the unique alias URLs, retrieve one of the plurality of stored interstitial web pages corresponding to the one of the unique alias URLs and serve the retrieved one of the plurality of stored interstitial web pages to the web browser.

5. A redirection server according to claim 2 comprising a page builder wherein the page builder is configured to retrieve from the database: the destination URL corresponding to the alias URL and the cookie corresponding to the alias URL and to generate the interstitial web page using the retrieved destination URL and cookie.

6. A redirection server according to claim 1 comprising a configuration interface comprising a field for receiving an input destination URL and a field for receiving cookie data wherein the redirection server is configured to associate the input destination URL with a new unique alias URL and to store and associate in the database the new unique alias URL, the destination URL and the cookie data.

7. A redirection server according to claim 6 wherein the configuration interface comprises a field for receiving an input requested alias URL wherein the redirection server is configured to check that the input requested alias URL is unique as compared to all other alias URLs in the database and, if so, to use the input requested alias URL for the new unique alias URL.

8. A redirection server according to claim lwherein the interstitial web page is configured to be displayed for a period of less than 3 seconds.

9. A redirection server according to claim 1 wherein the interstitial web page is configured to be displayed by the web browser for a period of 0 seconds.

10. A redirection server according to claim 1 comprising a facility configured to process resources identified by the destination URLs in the database to identify subject matter of the resources and to store in the database a record associating the identified subject matter with the corresponding alias URLs.

11. A redirection server according to claim 10 wherein the facility comprises web crawler software configured to access the resources and to identify concepts, keywords and/or key phrases in each of the resources.

12. A redirection server according to claim 10 wherein the redirection server is configured to search the database to determine any concepts, keywords and/or key phrases associated with the alias URL and to select the cookie based on the associated concepts, keywords and/or key phrases associated with the alias URL.

13. A redirection server according to claim 12 wherein the redirection server comprises records of offers associated with different ones of the concepts, keywords and/or key phrases, each of the offers associated with a corresponding cookie wherein the redirection server is configured to select the cookie by comparing a plurality of offers for the concepts, keywords and/or key phrases associated with the alias URL, identifying a greatest one of those offers and selecting the cookie corresponding to the greatest one of those offers.

14. A redirection server according to claim 13 comprising an ordering interface, the ordering interface providing a search tool configured to search for concepts, keywords and/or key phrases represented in the database; a selection tool configured to allow a user to select one or more of the concepts, keywords and/or key phrases represented in the database and returned by the search tool; and a field for receiving an offer to be associated with the selected one or more of the concepts, keywords and/or key phrases.

15. A redirection server according to claim 14 wherein the ordering interface comprises a field for receiving a cookie to be associated with the offer.

16. A redirection server according to claim 14 wherein the ordering interface comprises a user-selectable filter configured to cause the search tool to return for selection only concepts, keywords and/or key phrases associated with alias URLs that satisfy one or more performance criteria.

17. A redirection server according to claim 16 wherein the performance criteria include a rate at which the alias URLs corresponding to the concepts, keywords and/or key phrases in the database are being requested.

18. A system comprising a redirection server according to claim 2 in combination with an information server, the information server configured to deliver information in the form of an advertisement to the browser in response to receiving notification that the cookie is present on the browser.

19. A system according to claim 18 wherein the advertisement is a banner advertisement in a web page served to the browser.

20. A method for automatic information delivery, the method comprising:
obtaining cookie data associated with information to be delivered;
configuring a redirection server to associate an alias URL with: a destination URL identifying an internet-accessible resource and with the cookie data and to, in response to a request for the alias URL, serve an interstitial web page comprising a redirection to the resource at the destination URL and commands to serve the cookie data to a web browser originating the request for the alias URL.

21. A method according to claim 20 wherein obtaining the cookie data comprises retrieving the cookie data from an information server and the method comprises uploading the information to be delivered to the information server.

22. A method according to claim 21 wherein the information server is a server of an advertising network configured to deliver the information as advertisements embedded in web pages.

23. A method according to claim 22 wherein the information server is configured to deliver the information in the form of a banner advertisement in a web page served to the web browser.

24. A method according to claim 20 wherein the redirection server causes the interstitial web page to be displayed for less than 3 seconds.

25. A method according to claim 20 wherein the interstitial web page is configured to be displayed for zero seconds.

26. An automated method comprising:
accessing a database comprising associations between alias URLs and destination URLs, each of the destination URLs identifying an internet-accessible resource to retrieve the destination URLs;
using the destination URLs accessing the resources associated with the destination URLs and processing each of the resources to identify corresponding concepts, keywords and/or key phrases; and
associating the alias URLs with the corresponding concepts, keywords and/or key phrases in database records.

27. A method according to claim 26 comprising associating cookie data with one or more of the concepts, keywords and/or key phrases.

28. A method according to claim 27 comprising associating the cookie data with each of the alias URLs that is associated with the one or more of the concepts, keywords and/or key phrases.

29. A method according to claim 28 comprising receiving offers for the concepts, keywords and/or key phrases, each of the offers associated with corresponding cookie data and associating the cookie data with each of the alias URLs that are associated with the one or more of the concepts, keywords and/or key phrases comprises identifying the greatest offer for one of the concepts, keywords and/or key phrases and associating with those of the alias URLs associated with the one of the concepts, keywords and/or key phrases the cookie data associated with the identified greatest offer.

30. A method according to claim 26 comprising configuring a redirection server to, in response to a request for one of the alias URLs, serve an interstitial web page comprising a redirection to the resource at the corresponding destination URL and commands to serve the cookie data associated with the alias URL to a web browser originating the request for the alias URL.

31. A method for automatic information delivery, the method comprising:
obtaining information to be delivered;
configuring a redirection server to associate an alias URL with a destination URL identifying an internet-accessible resource;
in response to a request for the alias URL, serving an interstitial web page comprising a redirection to the resource at the destination URL and tagging a user device originating the request for the alias URL.

32. A method according to claim 31 comprising receiving cookie data associated with the information to be delivered wherein the interstitial web page is configured to serve the cookie data to the user device.

33. A method according to claim 32 wherein obtaining the cookie data comprises retrieving the cookie data from an information server and the method comprises uploading the information to be delivered to the information server.

34. A method according to claim 33 wherein the information server is a server of an advertising network configured to deliver the information as advertisements embedded in web pages.

35. A method according to claim 34 wherein the information server is configured to deliver the information in the form of a banner advertisement in a web page served to the web browser.

36. A method according to claim 31 herein the redirection server causes the interstitial web page to be displayed for less than 3 seconds.

37. A method according to claim 31 wherein the interstitial web page is configured to be displayed for zero seconds.

38. A method according to claim 31 wherein tagging the user device comprises receiving an ID characteristic from the user device and associating the ID characteristic with the alias URL.
